(19) United States
(12) Patent Application Publication
(10) Pub. No.: US 2025/0376887 A1
(43) Pub. Date: Dec. 11, 2025

(54) VEHICLE WINDOW SWITCH MODULE

(71) Applicant: GM GLOBAL TECHNOLOGY OPERATIONS LLC, Detroit, MI (US)

(72) Inventors: Haesol Nam, Incheon (KR); Bongbum Back, Incheon (KR); Youngseok Roh, Ansan (KR)

(73) Assignee: GM GLOBAL TECHNOLOGY OPERATIONS LLC, Detroit, MI (US)

(21) Appl. No.: 18/735,298

(22) Filed: Jun. 6, 2024

(51) Int. Cl. E05F 15/695

(52) U.S. Cl. CPC E05F 15/695; E05Y 2900/55

(57) ABSTRACT

A window switch module for operating a plurality of moveable windows in a vehicle includes a primary switch configured to selectively open and close each of the plurality of moveable windows. The window switch module also includes a plurality of secondary switches operatively connected to the primary switch. Each secondary switch is configured to select operation of at least one of the moveable windows via actuation of the main switch.

### INTRODUCTION

The present disclosure is drawn to a window switch module for a vehicle.

Most vehicles have at least some windows that may be opened and closed by a vehicle user. Power windows or electric windows are vehicle windows which may be raised and lowered by pressing a button or a switch, as opposed to using a crank handle. Power windows are usually inoperable when the car is not running. Some systems have a time delay feature leaving power applied to the windows and some other accessories for a brief period after the engine is stopped or until a passenger door is opened, at which time the window power is shut off.

Another feature is the “express-down” window, which allows the window to be fully lowered with one tap on the switch, as opposed to holding the switch down until the window retracts. Many vehicles have expanded on this feature, to include “express-up” on the driver's window and on all window switches for all passengers' convenience. This is done by activating the switch until a “click” response is felt. A power window lockout switch is a popular convenience feature that allows the driver to prevent passengers, usually children, from using the windows. Additionally, some vehicles offer the option to operate the windows from outside the car using a remote.

Power window switches may be configured as rocker switches, lever switches, buttons, etc. Typically, there is an individual switch at each window and a set of switches within easy reach of the driver, allowing the driver to operate all the windows. Power window switches may be arranged on interior portions of vehicle doors, on consoles, on the instrument panel, etc. For user convenience, power window switches may be grouped together with controls for other vehicle features, such as side mirrors, door locks, etc.

### SUMMARY

A window switch module for operating a plurality of moveable windows in a vehicle includes a primary switch configured to selectively open and close each of the plurality of moveable windows. The window switch module also includes a plurality of secondary switches operatively connected to the primary switch. Each secondary switch is configured to select operation of at least one of the moveable windows via actuation of the main switch.

The plurality of moveable windows may include a left-front window, a left-rear window, a right-front window, and a right-rear window.

The plurality of secondary switches may include first and second three-way switches. The first three-way switch may define a first position configured to select operation of the left-front window via the primary switch; a second position configured to select operation of the left-rear window via the primary switch; and a third position configured to deselect operation of each of the left-front window and the left-rear window via the primary switch in a first mode and select simultaneous operation of the left-front window and the left-rear window via the primary switch in a second mode.

The second three-way switch may define a first position configured to select operation of the right-front window via the primary switch; a second position configured to select operation of the right-rear window via the primary switch; and a third position configured to deselect operation of each of the right-front window and the right-rear window via the primary switch in a first mode and select simultaneous operation of the right-front window and the right-rear window via the primary switch in a second mode.

The second mode of operation of the first and second three-way switches may be defined when each of the first three-way switch and the second three-way switch is in its respective third position.

Alternatively, the plurality of secondary switches may include first, second, third, and fourth buttons. The first button may be configured to select operation of the left-front window via the primary switch. The second button may be configured to select operation of the right-front window via the primary switch. The third button may be configured to select operation of the left-rear window via the primary switch. The fourth button may be configured to select operation of the right-rear window via the primary switch.

The window switch module may also include a tertiary switch operatively connected to the primary switch and configured to select a predefined position, such as to vent the vehicle via at least one of the moveable windows using the actuation of the primary switch and at least one of the secondary switches.

The tertiary switch may be a joystick configured to operate in a two-dimensional plane.

The window switch module may additionally include a mirror position regulator configured to operate one or more vehicle side mirrors.

The window switch module may also include a function selector configured to select between operation of the primary switch and the mirror position regulator.

The window switch module may additionally include a window operation lockout button.

The window switch module may additionally include a switch configured to operate vehicle door locks.

A vehicle employing the above-described window switch module is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic top view of a vehicle having side doors and a tailgate with moveable windows operable from the vehicle's cabin, according to the present disclosure.

FIG. 2 is a schematic top view of an embodiment of a window switch module having a set of secondary switches operatively connected to a primary switch and arranged in the cabin of the vehicle shown in FIG. 1, according to the present disclosure.

FIG. 3 is a schematic side view of the secondary switches shown in FIG. 2, illustrating individual positions of the switches, according to the present disclosure.

FIG. 4 is a schematic top view of another embodiment of the window switch module having a set of secondary switches operatively connected to a primary switch and arranged in the cabin of the vehicle shown in FIG. 1, according to the present disclosure.

FIG. 5 is a schematic partial view of the cabin of the vehicle shown in FIG. 1, illustrating a vent position of a representative vehicle window controlled by the window switch module shown in FIGS. 3 and 4, according to the present disclosure.

### DETAILED DESCRIPTION

Embodiments of the present disclosure as described herein are intended to serve as examples. Other embodiments may take various and alternative forms. Additionally, the drawings are generally schematic and not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure.

Certain terminology may be used in the following description for the purpose of reference only, and thus are not intended to be limiting. For example, terms such as “above” and “below” refer to directions in the drawings to which reference is made. Terms such as “front”, “back”, “fore”, “aft”, “left”, “right”, “rear”, “side”, “upward”, “downward”, “top”, and “bottom”, etc., describe the orientation and/or location of portions of the components or elements within a consistent but arbitrary frame of reference, which is made clear by reference to the text and the associated drawings describing the components or elements under discussion.

Furthermore, terms such as “first”, “second”, “third”, and so on may be used to describe separate components. Such terminology may include the words specifically mentioned above, derivatives thereof, and words of similar import, and are used descriptively for the figures, and do not represent limitations on the scope of the disclosure, as defined by the appended claims. Moreover, the teachings may be described herein in terms of functional and/or logical block components and/or various processing steps. It should be realized that such block components may include a number of hardware, software, and/or firmware components configured to perform the specified functions.

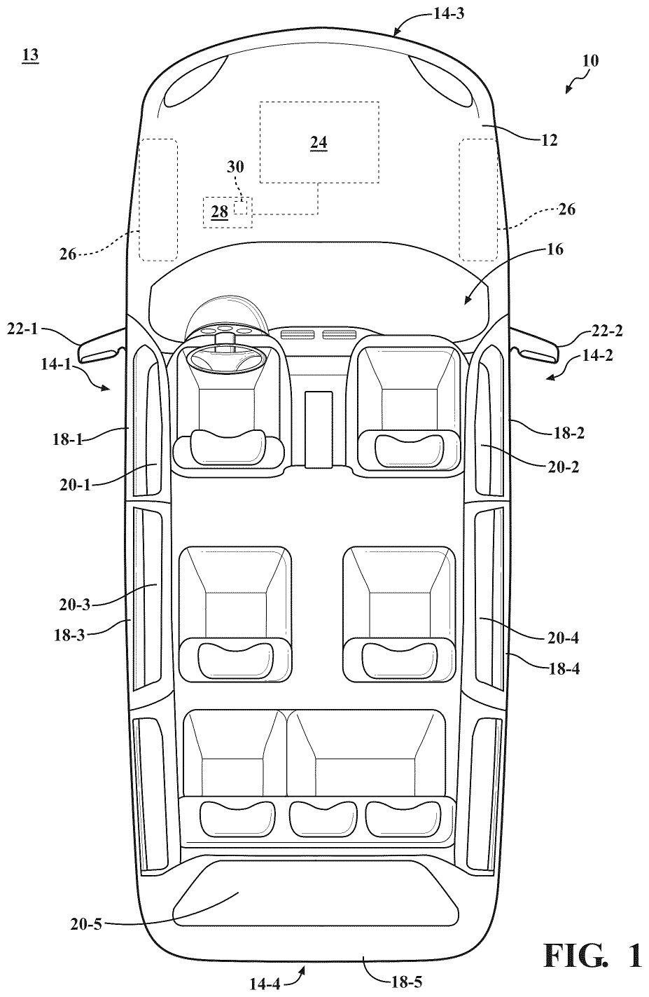

Referring to the drawings, wherein like reference numbers refer to like components throughout the several views, FIG. 1 schematically depicts a vehicle 10. The vehicle 10 is generally characterized by a vehicle body 12 surrounded by an external environment 13. The vehicle body 12 defines a vehicle interior or cabin 16 configured to accommodate a vehicle operator and passenger(s), for example in a generally seated position. The vehicle body 12 includes a left-side section 14-1, a right-side section 14-2, a front-end section 14-3, and a rear-end section 14-4. The vehicle body 12 also includes a plurality of side doors, such as left-front door 18-1, right-front door 18-2, left-rear door 18-3, and right-rear door 18-4, and a tailgate 18-5 (at the rear-end section 14-4) for gaining access to the vehicle cabin 16. Each of the doors 18-1, 18-2, 18-3, 18-4, 18-5 may be lockable from the inside or the outside of the vehicle and have a respective moveable window panel, 20-1, 20-2, 20-3, 20-4, 20-5 separating the vehicle interior from the external environment 14.

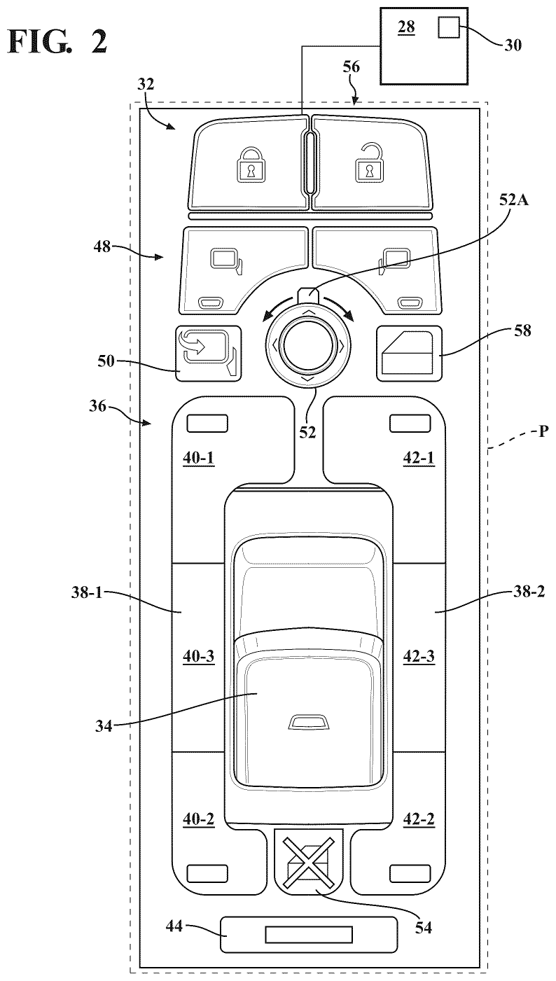

As shown in FIG. 1, the vehicle 10 may also include one or more side mirrors, such as a left-side mirror 22-1 and a right-side mirror 22-2 arranged on the respective left-side section 14-1 and right-side section 14-2 of the vehicle body 12. Such side mirrors 22-1, 22-2 may be positionally adjustable for use by the vehicle's driver and have a folding function. The vehicle 10 also includes a powerplant 24 configured to generate an output torque for powering the vehicle. The powerplant 24 may include an internal combustion engine, electric motor(s), and/or a fuel cell configured to propel the vehicle, such as via driven wheels 26. The vehicle 10 also includes an electronic controller 28 (shown in FIGS. 1 and 2). The electronic controller 28 may be a central processing unit (CPU) or a body control module (BCM) configured to receive data signals from various vehicle sensors and regulate operation of vehicle systems. The electronic controller 28 may be in operative communication with such vehicle systems and sensors via a data network, e.g., a Controller Area Network (CAN bus), arranged in the vehicle 10.

The electronic controller 28 includes a memory that is tangible and non-transitory. The memory may be a recordable medium that participates in providing computer-readable data or process instructions. Such a medium may take many forms, including but not limited to non-volatile media and volatile media. Non-volatile media used by the electronic controller 28 may include, for example, optical or magnetic disks and other persistent memory. Volatile media of each of the controller's memory may include, for example, dynamic random-access memory (DRAM), which may constitute a main memory. Such instructions may be transmitted by one or more transmission medium, including coaxial cables, copper wire and fiber optics, including the wires that comprise a system bus coupled to the vehicle systems. Memory of the electronic controller 28 may also include a flexible disk, hard disk, magnetic tape, other magnetic medium, a CD-ROM, DVD, other optical medium, etc. The electronic controller 28 may be equipped with a high-speed primary clock, requisite Analog-to-Digital (A/D) and/or Digital-to-Analog (D/A) circuitry, input/output circuitry and devices (I/O), as well as appropriate signal conditioning and/or buffer circuitry. Algorithms required by the electronic controller 28 or accessible thereby, generally indicated via numeral 30, may be stored in the memory and automatically executed to provide the required functionality.

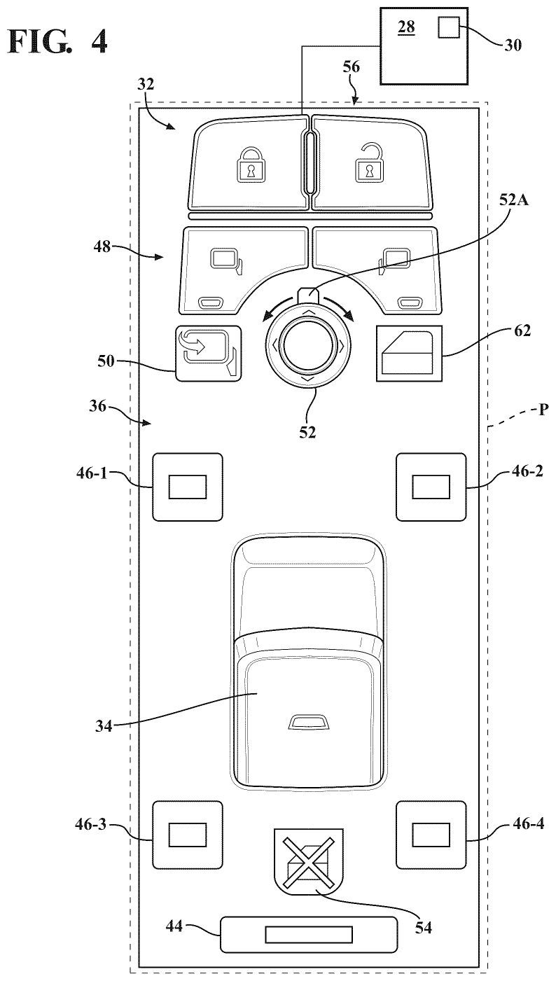

As shown in FIGS. 2 and 4, the electronic controller 28 is operatively connected to the doors 18-1, 18-2, 18-3, 18-4, 18-5 for central and/or remote locking/unlocking thereof and operation of the windows 20-1, 20-2, 20-3, 20-4, 20-5. Each of the windows 20-1, 20-2, 20-3, 20-4, 20-5 may be additionally controlled via a dedicated switch arranged in the cabin 16 proximately to the corresponding window, e.g., on a corresponding interior door panel. The vehicle 10 also includes a window switch module 32 arranged in the cabin 16 for operating each of the moveable windows 20-1, 20-2, 20-3, 20-4, 20-5. The window switch module 32 is in operative communication with the electronic controller 28. The window switch module 32 may be configured as a master control panel positioned within convenient reach of the vehicle's primary user, such as the driver, thus enabling the user to control each window as well as the door locks from a seated, vehicle operating position. For example, the window switch module 32 may generally reside in a two-dimensional plane P with actuation of various switches that are described in detail below affected in and/or perpendicular to the plane P. The window switch module 32 may be arranged on a driver's door (18-1 or 18-2) or on a center console or an instrument panel between the driver and front passenger.

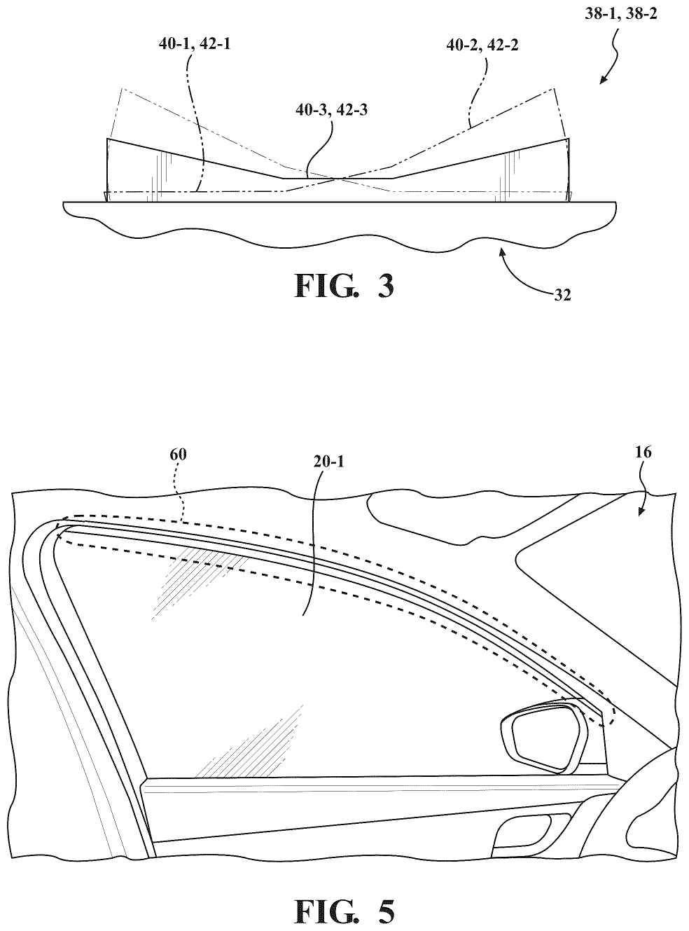

With continued reference to FIGS. 2 and 4, the window switch module 32 includes a primary switch 34 configured to selectively open and close each of the plurality of moveable windows 20-1, 20-2, 20-3, 20-4, 20-5. As shown, the primary switch 34 may be a lever-type actuator. The window switch module 32 also includes a plurality or set 36 of secondary switches operatively connected to the primary switch 34. Each secondary switch is configured to select operation of at least one of the windows 20-1, 20-2, 20-3, 20-4, 20-5 via actuation of the main switch 34. As shown in FIGS. 2 and 3, the secondary switch set 36 may include a first three-way switch 38-1 and a second three-way switch 38-2, e.g., rocker switches. The first three-way switch 38-1 and the second three-way switch 38-2 are electrically interconnected and operative to select one or more windows for control via actuation of the primary switch 34.

The first three-way switch 38-1 defines a first position 40-1 configured to select operation of the left-front window 20-1 via the primary switch 34. The first three-way switch 38-1 also defines a second position 40-2 configured to select operation of the left-rear window 20-3 via the primary switch 34. The first three-way switch 38-1 additionally defines a third or neutral position 40-3 configured to deselect operation of each of the left-front window 20-1 and the left-rear window 20-3 via the primary switch 34 in a respective first mode and select simultaneous operation of the left-front window and the left-rear window via the primary switch in a respective second mode. The second three-way switch 38-2 defines a first position 42-1 configured to select operation of the right-front window 20-2 via the primary switch 34. The second three-way switch 38-2 also defines a second position 42-2 configured to select operation of the right-rear window 20-4 via the primary switch 34. The second three-way switch 38-2 additionally defines a third (neutral) position 42-3 configured to deselect operation of each of the right-front window 20-2 and the right-rear window 20-4 via the primary switch 34 in a respective first mode and select simultaneous operation of the right-front window and the right-rear window via the primary switch in a respective second mode.

As shown in FIG. 3, the second mode of operation of the first and second three-way switches 38-1, 38-2 may be defined when each of the first and second three-way switches is in its respective third position 40-3, 42-3. In other words, the primary switch 34 may be enabled to simultaneously operate each of the left-front window 20-1, the left-rear window 20-3, the right-front window 20-2, and the right-rear window 20-4 when each of the first and second three-way switches 38-1, 38-2 is in its respective second mode. Once selected, coincident third positions 40-3, 42-3 of first and second three-way switches 38-1, 38-2 permit single switch control of multiple vehicle side windows. Combinations of positions of the first and second three-way switches 38-1, 38-2 are described below.

The first and second three-way switches 38-1, 38-2 may combine respective positions to individually operate each of the windows 20-1, 20-2, 20-3, 20-4 via the primary switch 34. When the first three-way switch 38-1 is in the first position 40-1 and the second three-way switch 38-2 is in its third position 42-3, actuation of the primary switch 34 may independently raise or lower the left-front window 20-1. Analogously, when the first three-way switch 38-1 is in the third position 40-3 and the second three-way switch 38-2 is in its first position 42-1, actuation of the primary switch 34 may independently raise or lower the right-front window 20-2.

When the first three-way switch 38-1 is in the second position 40-2 and the second three-way switch 38-2 is in its third position 42-3, actuation of the primary switch 34 may independently raise or lower the left-rear window 20-3. Analogously, when the first three-way switch 38-1 is in the third position 40-3 and the second three-way switch 38-2 is in its second position 42-2, actuation of the primary switch 34 may independently raise or lower the right-rear window 20-4. Alternatively, when the first three-way switch 38-1 is in the first position 40-1 and the second three-way switch 38-2 is in its first position 42-1, actuation of the primary switch 34 may simultaneously raise or lower the left-front window 20-1 and the right-front window 20-2. Analogously, when the first three-way switch 38-1 is in the second position 40-2 and the second three-way switch 38-2 is in its second position 42-2, actuation of the primary switch 34 may simultaneously raise or lower the left-rear window 20-3 and the right-rear window 20-4.

When the first three-way switch 38-1 is in the first position 40-1 and the second three-way switch 38-2 is in its second position 42-2, actuation of the primary switch 34 may simultaneously raise or lower the left-front window 20-1 and the right-rear window 20-4. Analogously, when the first three-way switch 38-1 is in the second position 40-2 and the second three-way switch 38-2 is in its first position 42-1, actuation of the primary switch 34 may simultaneously raise or lower the left-rear window 20-3 and the right-front window 20-2. Additionally, as noted above, when each of the first three-way switch 38-1 and the second three-way switch 38-2 is in its respective third position 40-3, 42-3, the primary switch is configured to simultaneously operate each of the left-front window, the right-front window, the left-rear window, and the right-rear window (20-1, 20-2, 20-3, 20-4). Such a functionality may be advantageous when all side windows need to be raised or lowered, such as to ventilate the vehicle on a hot day or from an odor.

As also shown in FIGS. 2 and 4, the window switch module 32 may include a separate tailgate window switch 44, such as a push button, configured to enable operation of the tailgate window 20-5. When actuated, e.g., depressed, alone, the tailgate window switch 44 may lower or raise the tailgate window 20-5. When actuated together with the first and second three-way switches 38-1, 38-2 being in their respective third positions 40-3, 42-3, the tailgate window switch 44 may enable the primary switch 34 to operate the tailgate window 20-5 simultaneously with each of the left-front window, the right-front window, the left-rear window, and the right-rear window (20-1, 20-2, 20-3, 20-4). In such an embodiment, ventilation of the vehicle may be further enhanced.

In an alternative embodiment of the window switch module 32 shown in FIG. 4, the secondary switch set 36 may include individual buttons for selecting positions of respective windows 20-1, 20-2, 20-3, 20-4 operable by the primary switch 34. As shown, a first button 46-1 is configured to select operation of the left-front window 20-1 via the primary switch 34. A second button 46-2 is configured to select operation of the right-front window 20-2 via the primary switch 34. A third button 46-3 is configured to select operation of the left-rear window 20-3 via the primary switch 34. A fourth button 46-4 is configured to select operation of the right-rear window 20-4 via the primary switch 34. Similar to coincident selection of third positions 40-3, 42-3 of first and second three-way switches 38-1, 38-2, simultaneous selection of each button 46-1, 46-2, 46-3, 46-4 permits single switch control (via primary switch 34) of multiple vehicle side windows.

The button 44 enabling operation of the tailgate window 20-5 via the primary switch 34 may also be incorporated in the embodiment of window switch module 32 shown in FIG. 4. The secondary switch set 36 may include additional switches or buttons (not shown) beyond first and second three-way switches 38-1, 38-2 or buttons 46-1, 46-2, 46-3, 46-4, and 44 for additional moveable windows, should the vehicle 10 include those. The primary switch 34, each of switches in the secondary switch set 36, and the tailgate window switch 44 may include a visual indicator, such as a light emitting diode (LED), configured to mark an actuation surface and/or the operating position of the corresponding switch.

With reference to FIGS. 2 and 4, the window switch module 32 may include side mirror controls. For example, such controls may include a mirror position selector 48 configured to select one of the left- and right-side mirrors 22-1, 22-2 for individual control of its orientation relative to the vehicle body 12. Additionally, a switch 50 may be arranged on the window switch module 32 for folding the left- and right-side mirrors 22-1, 22-2, e.g., for tight parking spaces. The window switch module 32 may additionally include a function selector 52 configured to permit selection between operation of the vehicle windows via the primary switch 34 and the mirror position via the regulator 48 or the switch 50. The function selector 52 may be a rotary actuator with a visual indicator 52A, such as a display or a pointer for the selected mode.

Alternatively, the function selector 52 may be a compound movement actuator having both rotary and joystick movement. For example, the function selector 52 may be additionally configured to control the orientation of an individual side mirror 22-1, 22-2 relative to the vehicle body 12 via the joystick movement once the particular mirror has been selected. The window switch module 32 may additionally include a window operation lockout switch 54 to prevent unauthorized raising/lowering of the windows 20-1, 20-2, 20-3, 20-4, 20-5. The window switch module 32 may further include a door lock switch 56 configured to centrally lock and unlock the vehicle doors 18-1, 18-2, 18-3, 18-4, 18-5. Either of the switches 54 and 56 may be configured as a push button.

The window switch module 32 shown in FIGS. 2 and 4 may further include a tertiary switch or button 58 operatively connected to the primary switch 34. The tertiary switch 58 is configured to select a predefined position 60, such as a narrow window opening of at least one of the moveable windows 20-1, 20-2, 20-3, 20-4, 20-5 (a representative window 20-1 is shown inn FIG. 5), creating a vehicle interior venting mode via actuation of the primary switch 34 and at least one of the secondary switches in the set 36. The narrow window opening 60 for one or more windows 20-1, 20-2, 20-3, 20-4, 20-5 may be useful in the event vehicle 10 needs to be locked and left unattended. The tertiary switch 58 may be configured as a joystick defining movement in the plane P for convenient operation by an individual with restricted or impaired hand use. Alternatively, the predefined position 60 of the windows 20-1, 20-2, 20-3, 20-4, 20-5 may be affected via actuation of the primary switch 34 in a specific position 62 of the function selector 52.

Overall, the window switch module 32 permits the use of a single primary switch to control operation of every moveable window in the vehicle 10 by the vehicle's main user, i.e., the driver. The primary switch works in cooperation with a set of secondary switches that allow selection of particular windows to be operated via the primary switch. The window switch module 32 may enable the primary switch to affect a predefined movement to individual windows, for example to provide venting of the vehicle. The window switch module 32 may include additional switches and buttons to control such features as side mirrors and door locks. Additionally, the above-described switches and buttons may be grouped together with the primary and secondary switches in a single plane of the window switch module 32 for ease of access and convenient mode selection by the vehicle user.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A window switch module for operating a plurality of moveable windows in a vehicle, the window switch module comprising:
a primary switch configured to selectively open and close each of the plurality of moveable windows; and
a plurality of secondary switches operatively connected to the primary switch, wherein each secondary switch is configured to select operation of at least one of the moveable windows via actuation of the main switch.

2. The window switch module of claim 1, wherein the plurality of moveable windows includes a left-front window, a left-rear window, a right-front window, and a right-rear window.

3. The window switch module of claim 2, wherein the plurality of secondary switches includes:
a first three-way switch defining:
a first position configured to select operation of the left-front window via the primary switch;
a second position configured to select operation of the left-rear window via the primary switch; and
a third position configured to deselect operation of each of the left-front window and the left-rear window via the primary switch in a first mode and select simultaneous operation of the left-front window and the left-rear window via the primary switch in a second mode; and
a second three-way switch defining:
a first position configured to select operation of the right-front window via the primary switch;
a second position configured to select operation of the right-rear window via the primary switch; and
a third position configured to deselect operation of each of the right-front window and the right-rear window via the primary switch in a first mode and select simultaneous operation of the right-front window and the right-rear window via the primary switch in a second mode.

4. The window switch module of claim 3, wherein the second mode of operation of the first and second three-way switches is defined when each of the first three-way switch and the second three-way switch is in its respective third position.

5. The window switch module of claim 2, wherein the plurality of secondary switches includes:
a first button configured to select operation of the left-front window via the primary switch;
a second button configured to select operation of the right-front window via the primary switch;
a third button configured to select operation of the left-rear window via the primary switch; and
a fourth button configured to select operation of the right-rear window via the primary switch.

6. The window switch module of claim 1, further comprising a tertiary switch operatively connected to the primary switch and configured to select a predefined position of at least one of the moveable windows via actuation of the primary switch and at least one of the secondary switches.

7. The window switch module of claim 1, further comprising a mirror position regulator configured to operate one or more vehicle side mirrors.

8. The window switch module of claim 7, further comprising a function selector configured to select between operation of the primary switch and the mirror position regulator.

9. The window switch module of claim 1, further comprising a window operation lockout switch.

10. The window switch module of claim 1, further comprising a switch configured to operate vehicle door locks.

11. A vehicle defining a vehicle interior and comprising:
a plurality of moveable windows, including a left-front window, a left-rear window, a right-front window, and a right-rear window;
a window switch module arranged within the vehicle interior and comprising:
a primary switch configured to selectively open and close each of the plurality of moveable windows; and
a plurality of secondary switches operatively connected to the primary switch, wherein each secondary switch is configured to select operation of at least one of the moveable windows via actuation of the main switch.

12. The vehicle of claim 11, wherein the plurality of secondary switches includes:
a first three-way switch defining:
a first position configured to select operation of the left-front window via the primary switch;
a second position configured to select operation of the left-rear window via the primary switch; and
a third position configured to deselect operation of each of the left-front window and the left-rear window via the primary switch in a first mode and select simultaneous operation of the left-front window and the left-rear window via the primary switch in a second mode; and
a second three-way switch defining:
a first position configured to select operation of the right-front window via the primary switch;
a second position configured to select operation of the right-rear window via the primary switch; and
a third position configured to deselect operation of each of the right-front window and the right-rear window via the primary switch in a first mode and select simultaneous operation of the right-front window and the right-rear window via the primary switch in a second mode.

13. The vehicle of claim 11, wherein the plurality of secondary switches includes:
a first button configured to select operation of the left-front window via the primary switch;
a second button configured to select operation of the right-front window via the primary switch;
a third button configured to select operation of the left-rear window via the primary switch; and
a fourth button configured to select operation of the right-rear window via the primary switch.

14. The vehicle of claim 13, wherein the second mode of operation of the first and second three-way switches is defined when each of the first three-way switch and the second three-way switch is in its respective third position.

15. The vehicle of claim 11, wherein the window switch module additionally includes a tertiary switch operatively connected to the primary switch and configured to select a predefined position of at least one of the moveable windows via actuation of the primary switch and at least one of the secondary switches.

16. The vehicle of claim 11, wherein the window switch module additionally includes a mirror position regulator configured to operate one or more vehicle side mirrors.

17. The vehicle of claim 16, wherein the window switch module additionally includes a function selector configured to select between operation of the primary switch and the mirror position regulator.

18. The vehicle of claim 11, wherein the window switch module additionally includes a window operation lockout button.

19. The vehicle of claim 11, wherein the window switch module additionally includes a switch configured to operate vehicle door locks.

20. A master window switch module for operating a plurality of moveable windows, including a left-front window, a left-rear window, a right-front window, and a right-rear window in a vehicle, the window switch module comprising:
a primary switch configured to selectively open and close each of the plurality of moveable windows; and
a plurality of secondary switches operatively connected to the primary switch, wherein each secondary switch is configured to select operation of at least one of the moveable windows via actuation of the main switch, wherein the plurality of secondary switches includes:
a first three-way switch defining:
a first position configured to select operation of the left-front window via the primary switch;
a second position configured to select operation of the left-rear window via the primary switch; and
a third position configured to deselect operation of each of the left-front window and the left-rear window via the primary switch in a first mode and select simultaneous operation of the left-front window and the left-rear window via the primary switch in a second mode; and
a second three-way switch defining:
a first position configured to select operation of the right-front window via the primary switch;
a second position configured to select operation of the right-rear window via the primary switch; and
a third position configured to deselect operation of each of the right-front window and the right-rear window via the primary switch in a first mode and select simultaneous operation of the right-front window and the right-rear window via the primary switch in a second mode;
wherein the second mode of operation of the first and second three-way switches is defined when each of the first three-way switch and the second three-way switch is in its respective third position.
